(19) United States
(12) Patent Application Publication
(10) Pub. No.: US 2014/0036879 A1
(43) Pub. Date: Feb. 6, 2014

(54) Method and Apparatus for Configuring Transmission of a Power Headroom Report in Carrier Aggregation Systems

(71) Applicant: Juho Pirskanen, Tampere (FI)

(72) Inventor: Juho Pirskanen, Tampere (FI)

(73) Assignee: RENESAS MOBILE CORPORATION, Tokyo (JP)

(21) Appl. No.: 13/984,895

(22) PCT Filed: Feb. 13, 2012
(86) PCT No.: PCT/IB2012/050642

§ 371 Date: Oct. 28, 2013

Related U.S. Application Data
(60) Provisional application No. 61/442,262, filed on Feb. 13, 2011.

(51) Int. Cl. H04W 52/36

(52) U.S. Cl. CPC H04W 52/365
USPC 370/336

(57) ABSTRACT

A method, apparatus and computer program product are provided that may support power headroom reporting in conjunction with carrier aggregation, such as the secondary cell(s) of a network that supports carrier aggregation. A method, apparatus and computer program product may be configured to receive a command from a primary cell indicating that a connection with a secondary cell is to be activated, receive scheduling information for the secondary cell and cause a power headroom report including actual power headroom parameters, such as at least one of actual power headroom or P_{cmax}, to be provided no later than in conjunction with an initial transmission following activation of the secondary cell.

### TECHNICAL FIELD

Embodiments of the present invention relate generally to wireless communication technology, and more particularly, to a method, apparatus and computer program product for causing a power headroom report to be provided in conjunction with activation of a secondary cell.

### BACKGROUND

A mobile terminal serviced by a single cell may provide power headroom reports to the base station of the serving cell. With respect to the uplink between the mobile terminal and the base station, for example, a power headroom report may identify the difference between the maximum transmit power of the mobile terminal and the estimated power for a physical uplink shared channel transmission in the current subframe. In some instances, the base station may then modify the transmission parameters based upon the power headroom report.

While power headroom reporting is routinely performed in an instance in which a mobile terminal is serviced by a single cell, power headroom reporting is only beginning to be considered in conjunction with carrier aggregation and, more particularly, the secondary cell(s) of a network that supports carrier aggregation. In this regard, carrier aggregation provides for a mobile terminal to be serviced by both a primary cell and one or more secondary cells. A primary cell operates on a primary frequency and performs the initial connection establishment procedure, initiates the connection re-establishment procedure or is indicated as the primary cell in a handover procedure. A secondary cell operates on a secondary frequency and may be configured once a radio resource control (RRC) connection is established and may be used to provide additional radio resources.

### SUMMARY

A method, apparatus and computer program product are provided in accordance with an example embodiment that may support power headroom reporting in conjunction with carrier aggregation, such as the secondary cell(s) of a network that supports carrier aggregation. In this regard, the method, apparatus and computer program product of an example embodiment may provide for power headroom reporting in conjunction with the activation of a secondary cell such that the secondary cell may thereafter modify transmission parameters based upon the power headroom report to provide for more efficient and/or higher quality communications with a mobile terminal.

In one example embodiment, a method for use in a mobile terminal is provided that includes receiving a command from a primary cell indicating that a connection with a secondary cell is to be activated, receiving scheduling information for the secondary cell and causing a power headroom report including actual power headroom parameters, such as at least one of actual power headroom or P_{cmax}, to be provided for receipt by the secondary cell no later than in conjunction with an initial transmission following activation of the secondary cell. In an example embodiment, the method may include causing the power headroom report to be provided following receipt of the scheduling information for the secondary cell. The method of an example embodiment may comprise causing the power headroom report to be provided following receipt of an uplink grant on the secondary cell and/or in an initial subframe after the activation of the secondary cell which has a valid uplink grant. In one example embodiment, the method may comprise receiving the command at subframe n, receiving the scheduling information at subframe n+8, and causing the power headroom report to be provided at subframe n+12.

In another example embodiment, an apparatus for use in a mobile terminal is provided that includes a processing system, which may be embodied by processing circuitry comprising a computer program and a memory. The processing system is configured to receive a command from a primary cell indicating that a connection with a secondary cell is to be activated, receive scheduling information for the secondary cell and cause a power headroom report including actual power headroom parameters, such as at least one of actual power headroom or P_{cmax}, to be provided for receipt by the secondary cell no later than in conjunction with an initial transmission following activation of the secondary cell. In an example embodiment, the processing system is arranged to cause the power headroom report to be provided following receipt of the scheduling information for the secondary cell. The processing system of an example embodiment may be configured to cause the power headroom power report to be provided by causing the power headroom report to be provided following receipt of an uplink grant on the secondary cell and/or in an initial subframe after the activation of the secondary cell which has a valid uplink grant. In one example embodiment, the processing system may be configured to receive the command at subframe n, receive the scheduling information at subframe n+8, and cause the power headroom report to be provided at subframe n+12.

In a further example embodiment, a computer program product is provided that includes a set of instructions, which, when executed by a user equipment, cause the user equipment to receive a command from a primary cell indicating that a connection with a secondary cell is to be activated, to receive scheduling information for the secondary cell and to cause a power headroom report including actual power headroom parameters, such as at least one of actual power headroom or Pₘₐₓ, to be provided for receipt by the secondary cell no later than in conjunction with an initial transmission following activation of the secondary cell. In an example embodiment, the set of instructions instructions cause the power headroom report to be provided following receipt of the scheduling information for the secondary cell. The set of instructions of an example embodiment cause the power headroom report to be provided following receipt of an uplink grant on the secondary cell and/or in an initial subframe after the activation of the secondary cell which has a valid uplink grant. In one example embodiment, the set of instructions cause the user equipment to receive the command at subframe n, to receive the scheduling information at subframe n+8, and to provide the power headroom report at subframe n+12.

In yet another example embodiment, an apparatus is provided that includes means for receiving a command from a primary cell indicating that a connection with a secondary cell is to be activated, means for receiving scheduling information for the secondary cell and means for causing a power headroom report including actual power headroom parameters, such as at least one of actual power headroom or P_{cmax}, to be provided for receipt by the secondary cell no later than in conjunction with an initial transmission following activation of the secondary cell. In an example embodiment, the means for causing the power headroom report to be provided may include means for causing the power headroom report to be provided following receipt of the scheduling information for the secondary cell. The means for causing the power headroom report to be provided may, in an example embodiment, include means for causing the power headroom report to be provided following receipt of an uplink grant on the secondary cell and/or in an initial subframe after the activation of the secondary cell which has a valid uplink grant. In one example embodiment, the apparatus may include means for receiving the command at subframe n, receiving the scheduling information at subframe n+8, and causing the power headroom report to be provided at subframe n+12.

### BRIEF DESCRIPTION OF THE DRAWINGS

Having thus described certain embodiments of the invention in general terms, reference will now be made to the accompanying drawings, which are not necessarily drawn to scale, and wherein:

FIG. 1 illustrates one example of a communication system according to an embodiment of the present invention;

FIG. 2 illustrates the communication between a base station and a mobile terminal in conjunction with the activation of a secondary cell according to one embodiment of the present invention;

FIG. 3 illustrates a block diagram of an apparatus in accordance with an example embodiment of the present invention; and

FIG. 4 is a flowchart illustrating operations performed in accordance with an example embodiment of the present invention from the perspective of a mobile terminal.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout.

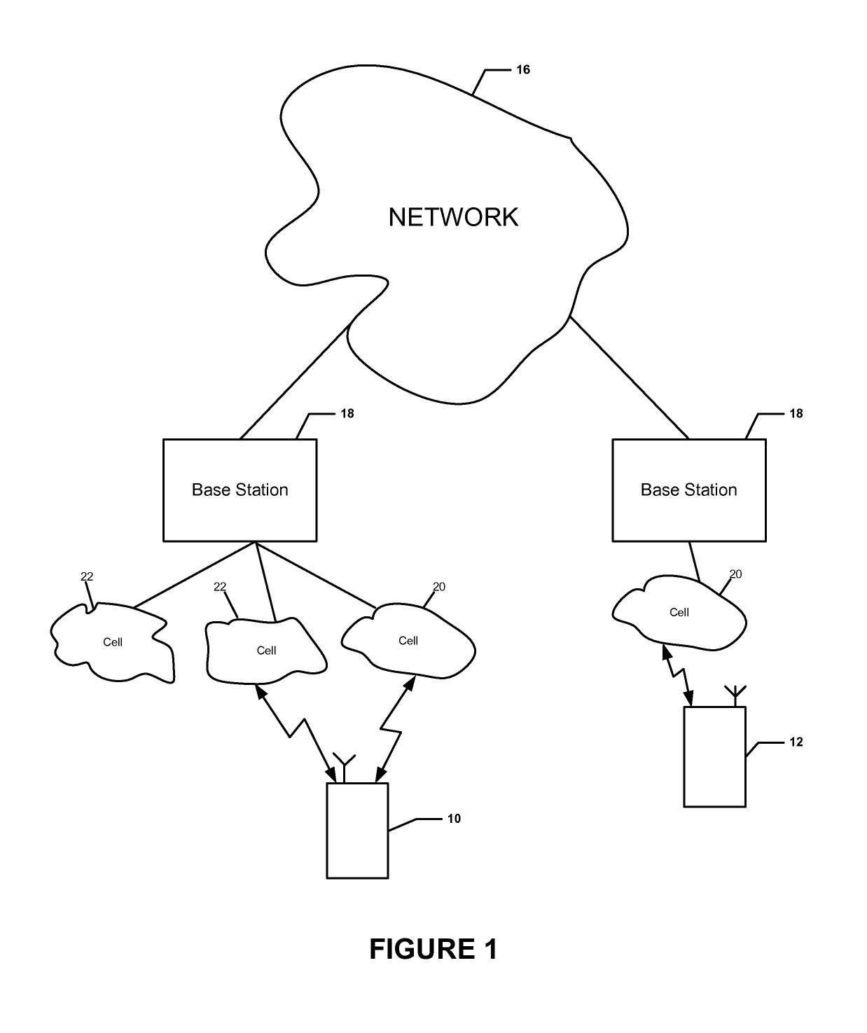

In carrier aggregation, such as is being developed in conjunction with Long Term Evolution-Advanced (LTE-A), a mobile terminal may be served by a primary cell and one or more secondary cells. While a system that provides carrier aggregation may be configured in various different manners, FIG. 1 illustrates a generic system diagram in which a device such as a mobile terminal 10 is shown in an example communication environment in which embodiments of the present invention may be employed. As shown in FIG. 1, an embodiment of a system in accordance with an example embodiment of the present invention may include a first communication device (e.g., mobile terminal 10) and a second communication device 12 that may each be capable of communication with a network 16 (e.g., a core network). The second communication device is provided as an example to illustrate potential multiplicity with respect to instances of other devices that may be included in the network and that may practice example embodiments. While the network may be configured in accordance with LTE-A, the network may employ other mobile access mechanisms such as wideband code division multiple access (W-CDMA), CDMA2000, global system for mobile communications (GSM), general packet radio service (GPRS), long term evolution (LTE) and/or the like.

The network 16 may include a collection of various different nodes, devices or functions that may be in communication with each other via corresponding wired and/or wireless interfaces. As such, the illustration of FIG. 1 should be understood to be an example of a broad view of certain elements of the system and not an all inclusive or detailed view of the system or the network. One or more communication terminals such as the mobile terminal 10 and the second communication device 12 may be in communication with each other or other devices via the network. In some cases, each of the communication terminals may include an antenna or antennas for transmitting signals to and for receiving signals from a base station 18. The base station could be, for example, part of one or more cellular or mobile networks or public land mobile networks (PLMNs). In turn, other devices such as processing devices (e.g., personal computers, server computers or the like) may be coupled to the mobile terminal and/or the second communication device via the network.

In some example embodiments, the mobile terminal 10 (and/or the second communication device 12) may be a mobile communication device such as, for example, a mobile telephone, portable digital assistant (PDA), pager, laptop computer, or any of numerous other hand held or portable communication devices, computation devices, content generation devices, content consumption devices, or combinations thereof. As such, the mobile terminal may include one or more processors that may define processing circuitry either alone or in combination with one or more memories. The processing circuitry may utilize instructions stored in the memory to cause the mobile terminal to operate in a particular way or execute specific functionality when the instructions are executed by the one or more processors. The mobile terminal may also include communication circuitry and corresponding hardware/software to enable communication with other devices and/or the network 16.

As noted above, the communication devices may be provided with access to the network 16 via a base station 18 or other communication node (e.g., evolved node B (eNB), node B or other base station or access point). As shown, each base station may serve a coverage area divided into one or more cells. In a carrier aggregation context, one of the cells may be the primary cell 20 and, as such, may perform the initial connection establishment procedure with the mobile terminal 10, may initiate the connection re-establishment procedure with the mobile terminal or may be indicated as the primary cell in the handover procedure. One or more of the other cells may be secondary cell(s) 22, which may be configured once an RRC connection is established and may be relied upon to provide radio resources in addition to those provided by the primary cell.

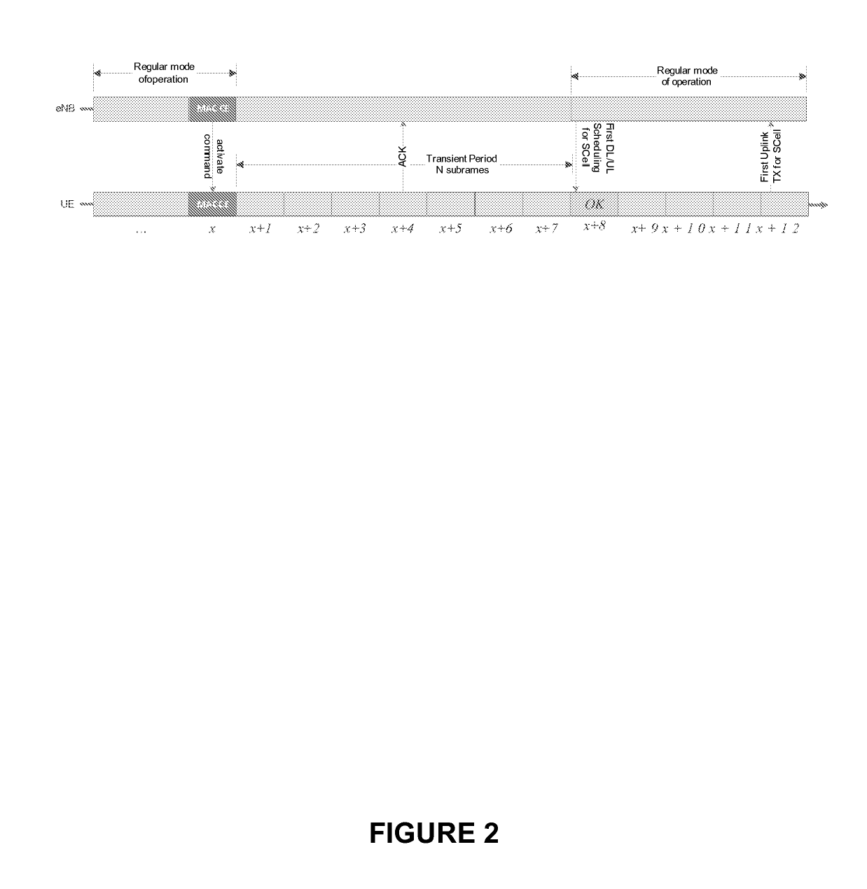

In conjunction with carrier aggregation, the mobile terminal 10 may initially establish a connection with the primary cell 20 on a primary frequency. In order to provide additional radio resources, a connection may then be established with one or more secondary cells 22 on respective secondary frequencies. In accordance with one example, the communication between base station 18 that supports the cells and the mobile terminal in regards to the activation of a secondary cell is shown in FIG. 2. In the illustrated embodiment and during a regular mode of operation, the base station may initially transmit a command to the mobile terminal that instructs activation of a secondary cell as an uplink (UL), downlink (DL) or both. Indeed, the initial command to activate the secondary cell is shown to occur in subframe x and serves as a reference point for subsequent subframes designated as x+1, x+2, . . . x+12.

Following the initial instruction from the base station 18 to activate a secondary cell 22, a transient period is commenced during which the mobile terminal 10 prepares for activation of the secondary cell. While the transient period may extend for any number of subframes, the transient period of the illustrated embodiment extends for seven subframes, that is, subframes x+1 through x+7. Also following the initial instruction from the base station to activate the secondary cell, the mobile terminal may acknowledge the instruction. While the acknowledgement may occur at various times following the initial instruction, the acknowledgement is transmitted by the mobile terminal during the transient period, such as in subframe x+4 in the illustrated embodiment.

Upon completion of the transient period, the secondary cell is activated and the regular mode of operation between the base station 18 and the mobile terminal 10 resumes, such as beginning at subframe x+8 in the embodiment of FIG. 2. Once the regular mode of operation is resumed, the base station may transmit a message to the mobile terminal that includes scheduling information for the uplink and/or downlink that is to be established with the secondary cell. The message that includes scheduling information may be transmitted during any subframe once the regular mode of operation has been resumed. In the illustrated embodiment, however, the message that includes scheduling information is transmitted by the base station to the mobile terminal during the initial subframe once the regular mode of operation has resumed, such as subframe x+8 in FIG. 2. Among other things, an uplink grant may be transmitted from the base station 18 to the mobile terminal as part of or in conjunction with the scheduling information.

Following transmission of the message that includes scheduling information, the initial transmission via the newly activated uplink or downlink with the secondary cell 22 may, in some embodiments, not occur for several subframes to allow the scheduling information to be appropriately applied. In the illustrated embodiment in which an uplink is established with the newly activated secondary cell, the initial transmission from the mobile terminal 10 to the secondary cell may occur, for example, four subframes following the subframe during which the message containing the scheduling information is received, that is, during subframe x+12. Following activation, the mobile terminal may utilize the uplink and/or downlink established with the secondary cell to supplement its connection with the primary cell 20.

In accordance with an example embodiment, a power headroom report may be provided no later than in conjunction with an initial transmission following activation of the secondary cell, such as during subframe x+12 in the embodiment shown in FIG. 2. As an uplink grant may be received by the mobile terminal 10 in conjunction with or as part of the scheduling information, the power headroom report may also be provided following receipt of an uplink grant on the secondary cell. In one example embodiment, the power headroom report may be provided in an initial subframe after the activation of the secondary cell which has a valid uplink grant, such as subframe x+12 in the illustrated embodiment.

In terms of timing, the power headroom report may be provided in the initial transmission following the message that includes the scheduling information. In other embodiments, the power headroom report may be provided prior to the message that includes the scheduling information. In this instance, however, the communication with the secondary cell may be disadvantageously discontinuous since the message containing the power headroom report may be followed by a message containing the scheduling information which, in turn, may be followed by a delay of several subframes prior to commencing ongoing communication with the secondary cell.

The power headroom report may include actual power headroom parameters. While various power headroom parameters may be provided in the power headroom report, the power headroom report of one embodiment may include the actual power headroom, the maximum power headroom or both. By providing the actual power headroom parameters, the power headroom parameters may more closely represent the actual power headroom associated with the uplink and/or downlink established with the secondary cell 22. In this regard, the provision of the power headroom report once the secondary cell has been activated allows actual power headroom parameters to be determined by the mobile terminal 10 and provided to the secondary cell. By including the power headroom report in the initial transmission following activation of the secondary cell, the power headroom report is provided as soon as practical while still being able to provide the actual power headroom parameters. Conversely, if the power headroom report had been provided prior to the activation of the secondary cell, such as during the transient period, virtual power headroom parameters would have had to be provided. Virtual power headroom parameters may be less accurate than the actual power headroom parameters since virtual power headroom parameters may be based on a reference transport format, as opposed to actual data such that the resulting communication between the mobile terminal and the secondary cell may be conducted in a less efficient manner and/or with a lower quality of service. While the virtual power headroom parameters may be eventually replaced by actual power headroom parameters as a result of a periodic updating of the power headroom parameters, this updating of the power headroom parameters will not occur for some period of time, during which the communication between the mobile terminal and the secondary cell may be sub-optimal.

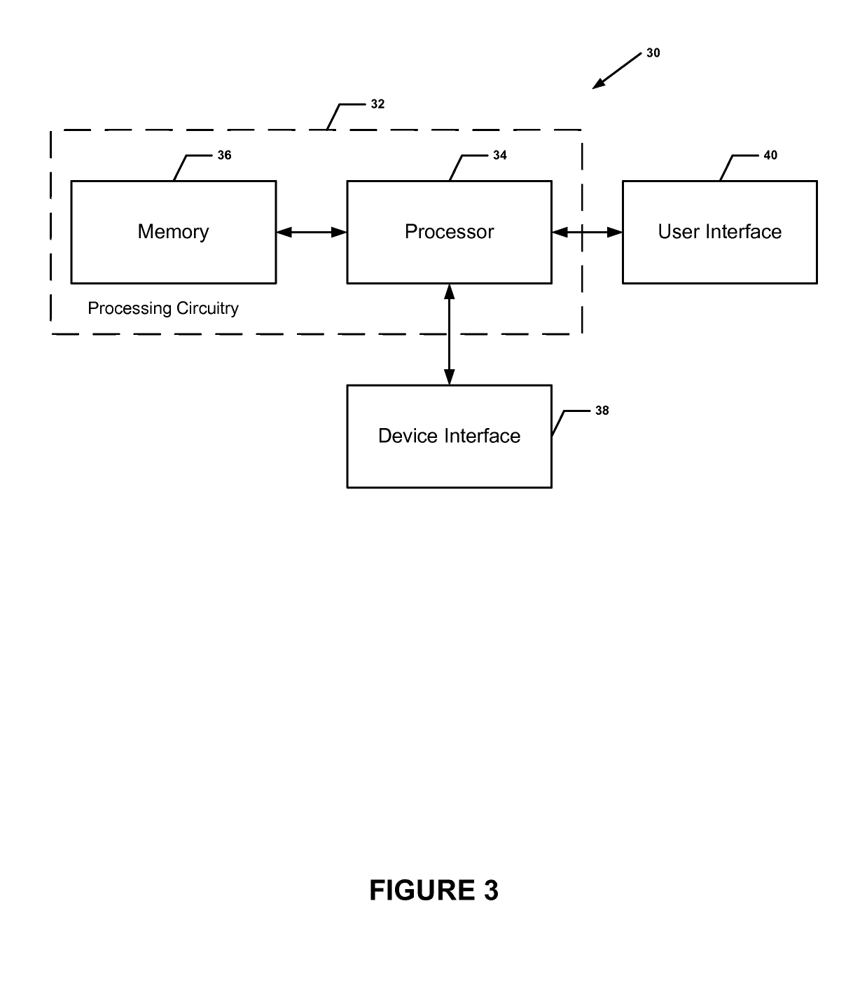

The mobile terminal 10 may be embodied as or otherwise include an apparatus 30 as generically represented by the block diagram of FIG. 3. In this regard, the apparatus may be configured to provide a power headroom report that includes actual power headroom parameters in conjunction with an initial transmission following activation of the secondary cell. While the apparatus may be employed, for example, by a mobile terminal, it should be noted that the components, devices or elements described below may not be mandatory and thus some may be omitted in certain embodiments. Additionally, some embodiments may include further or different components, devices or elements beyond those shown and described herein.

As shown in FIG. 3, the apparatus 30 may include or otherwise be in communication with a processing system including, for example, processing circuitry 32 that is configurable to perform actions in accordance with example embodiments described herein. The processing circuitry may be configured to perform data processing, application execution and/or other processing and management services according to an example embodiment of the present invention. In some embodiments, the apparatus or the processing circuitry may be embodied as a chip or chip set. In other words, the apparatus or the processing circuitry may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus or the processing circuitry may therefore, in some cases, be configured to implement an embodiment of the present invention on a single chip or as a single “system on a chip.” As such, in some cases, a chip or chipset may constitute means for performing one or more operations for providing the functionalities described herein.

In an example embodiment, the processing circuitry 32 may include a processor 34 and memory 36 that may be in communication with or otherwise control a device interface 38 and, in some cases, a user interface 40. As such, the processing circuitry may be embodied as a circuit chip (e.g., an integrated circuit chip) configured (e.g., with hardware, software or a combination of hardware and software) to perform operations described herein. However, in some embodiments taken in the context of the mobile terminal 10, the processing circuitry may be embodied as a portion of a mobile computing device or other mobile terminal.

The user interface 40 (if implemented) may be in communication with the processing circuitry 32 to receive an indication of a user input at the user interface and/or to provide an audible, visual, mechanical or other output to the user. As such, the user interface in the context of a mobile terminal 10 may include, for example, a keyboard, a mouse, a joystick, a display, a touch screen, a microphone, a speaker, and/or other input/output mechanisms.

The device interface 38 may include one or more interface mechanisms for enabling communication with other devices and/or networks. In some cases, the device interface may be any means such as a device or circuitry embodied in either hardware, or a combination of hardware and software that is configured to receive and/or transmit data from/to a network and/or any other device or module in communication with the processing circuitry 32. In this regard, the device interface may include, for example, an antenna (or multiple antennas) and supporting hardware and/or software for enabling communications with a wireless communication network and/or a communication modem or other hardware/software for supporting communication via cable, digital subscriber line (DSL), universal serial bus (USB), Ethernet or other methods.

In an example embodiment, the memory 36 may include one or more non-transitory memory devices such as, for example, volatile and/or non-volatile memory that may be either fixed or removable. The memory may be configured to store information, data, applications, instructions or the like for enabling the apparatus 30 to carry out various functions in accordance with example embodiments of the present invention. For example, the memory could be configured to buffer input data for processing by the processor 34. Additionally or alternatively, the memory could be configured to store instructions for execution by the processor. As yet another alternative, the memory may include one of a plurality of databases that may store a variety of files, contents or data sets. Among the contents of the memory, applications may be stored for execution by the processor in order to carry out the functionality associated with each respective application. In some cases, the memory may be in communication with the processor via a bus for passing information among components of the apparatus.

The processor 34 may be embodied in a number of different ways. For example, the processor may be embodied as various processing means such as one or more of a microprocessor or other processing element, a coprocessor, a controller or various other computing or processing devices including integrated circuits such as, for example, an ASIC (application specific integrated circuit), an FPGA (field programmable gate array), or the like. In an example embodiment, the processor may be configured to execute instructions stored in the memory 36 or otherwise accessible to the processor. As such, whether configured by hardware or by a combination of hardware and software, the processor may represent an entity (e.g., physically embodied in circuitry—in the form of processing circuitry 32) capable of performing operations according to embodiments of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the operations described herein.

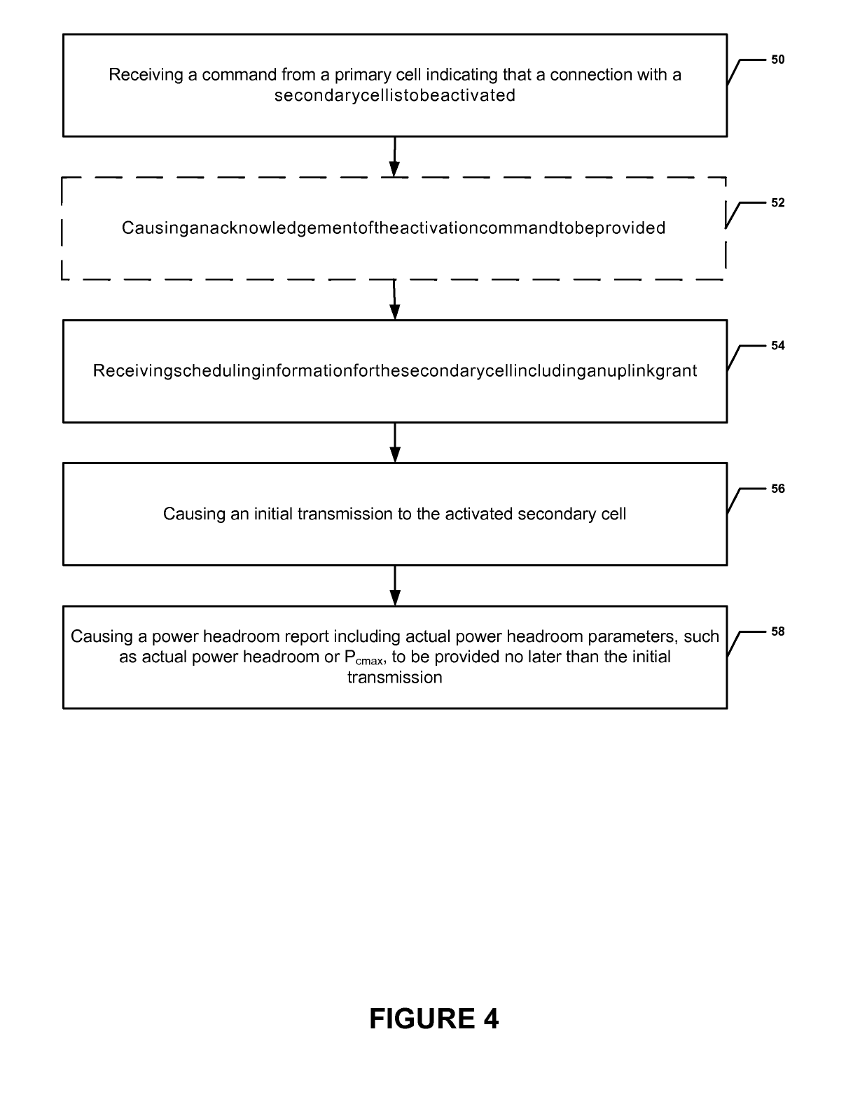

Although an example of the exchange of messages between the mobile terminal 10 and the base station 18 in conjunction with the activation of a secondary cell 22 in accordance with an example embodiment of the present invention has been described above and illustrated in FIG. 2, the operations performed from the perspective of the mobile terminal are also shown in FIG. 4. In this regard, FIG. 4 is a flowchart of a system, method and program product according to example embodiments of the invention taken from the perspective of the mobile terminal. It will be understood that each block of the flowchart, and combinations of blocks in the flowchart, may be implemented by various means, such as hardware, firmware, processor, circuitry and/or other device associated with execution of software including one or more computer program instructions. For example, one or more of the procedures described above may be embodied by computer program instructions. In this regard, the computer program instructions which embody the procedures described above may be stored by a memory device of an apparatus employing an embodiment of the present invention and executed by a processor in the apparatus. As will be appreciated, any such computer program instructions may be loaded onto a computer or other programmable apparatus (e.g., hardware) to produce a machine, such that the resulting computer or other programmable apparatus provides for implementation of the functions specified in the flowchart block(s). These computer program instructions may also be stored in a non-transitory computer-readable storage memory that may direct a computer or other programmable apparatus to function in a particular manner, such that the instructions stored in the computer-readable storage memory produce an article of manufacture, the execution of which implements the function specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

Referring now to FIG. 4, the apparatus 30 includes means, such as the processing circuitry 32, the processor 34, the device interface 38 or the like, for reviewing a command from the base station 18 via the primary cell 20 indicating that a secondary cell 22 is to be activated. See block 50. A transient period is then entered as described above in conjunction with FIG. 2 during which the mobile terminal 10 may optionally provide an acknowledgement of the activation command. As such, the apparatus may include means, such as the processing circuitry, the processor, the device interface or the like, for causing an acknowledgement of the activation command to be provided to the base station. See block 52. The apparatus may also include means, such as the processing circuitry, the processor, the device interface or the like, for receiving scheduling information for the secondary cell. See block 54. In one embodiment described above and illustrated in FIG. 2, the scheduling information may be provided via a message that is transmitted to the mobile terminal during the initial subframe following the transient period and upon activation of the secondary cell. An uplink grant may be received as part of or concurrent with the scheduling information in accordance with one example embodiment.

Based upon the scheduling information, the mobile terminal 10 may then communicate with the secondary cell 22. As such, the apparatus 30 may include means, such as the processing circuitry 32, the processor 34, the device interface 38 or the like, for causing an initial transmission to be provided to the activated secondary cell. See block 56. This initial transmission may include a power headroom report as the apparatus may include means, such as the processing circuitry, the processor, the device interface or the like, for causing a power headroom report to be provided no later than the initial transmission. See block 58. While the mobile terminal of one embodiment may cause the power headroom report to be provided prior to the initial transmission, the mobile terminal may, in any event, be configured to cause the power headroom report to be provided no later than the initial transmission, such as concurrent with the initial transmission as shown in the illustrated embodiment. The power headroom report that is provided may advantageously include actual power headroom parameters, such as actual power headroom (PHR) and/or P_{cmax}. In this regard, P_{cmax}(i) may be defined as the configured maximum transmission power of the mobile terminal in subframe i for serving cell c, such as set forth by 3GPP TS 36.101 version 10.1.1. For example, P_{cmax} may be defined as the maximum transmission power of the mobile terminal reduced by additional power reduction parameters such as maximum power reduction (MPR) or, if the network signalled power is smaller, then P_{cmax} is set equal to the network signaled power (P_{EMAXc}). As such, the mobile terminal and the secondary cell may then communicate with those subsequent communications being conducted in an efficient manner with an expectation of a meaningful quality of service since those communications are based upon actual power headroom parameters that are provided at the onset of the communications between the mobile terminal and the secondary cell. While described above in conjunction with the activation of an uplink from the mobile terminal to the secondary cell, the method, apparatus and computer program product may also establish a downlink from the secondary cell to the mobile terminal or both an uplink and a downlink between the mobile terminal and the secondary cell in an analogous manner in accordance with other embodiments of the present invention.

In some embodiments, certain ones of the operations above may be modified or further amplified. For example, FIG. 4 illustrates, by dashed lines, additional optional operations that may be included in some embodiments, but not other embodiments. It should be appreciated that each of these optional operations may be included with the other operations either alone or in combination with any others among the features described herein.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for use in a mobile terminal, the method comprising:
receiving a command from a primary cell indicating that a connection with a secondary cell is to be activated;
receiving scheduling information for the secondary cell; and
causing a power headroom report including actual power headroom parameters to be provided for receipt by the secondary cell no later than in conjunction with an initial transmission following activation of the secondary cell.

2. A method according to claim 1, wherein causing the power headroom report to be provided comprises causing the power headroom report to be provided following receipt of the scheduling information for the secondary cell.

3. A method according to claim 1, wherein causing the power headroom report to be provided comprises causing the power headroom report to be provided following receipt of an uplink grant on the secondary cell.

4. A method according to claim 1, wherein causing the power headroom report to be provided comprises causing the power headroom report to be provided in an initial subframe after the activation of the secondary cell which has a valid uplink grant.

5. A method according to claim 1, wherein causing the power headroom report to be provided comprises causing at least one of actual power headroom or P_{cmax} to be provided.

6. A method according to claim 1, wherein receiving the command comprises receiving the command at subframe n, wherein receiving the scheduling information comprises receiving the scheduling information at subframe n+8, and wherein causing the power headroom report to be provided comprises causing the power headroom report to be provided at subframe n+12.

7. An apparatus for use in a mobile terminal, the apparatus comprising a processing system arranged to:
receive a command from a primary cell indicating that a connection with a secondary cell is to be activated;
receive scheduling information for the secondary cell; and
cause a power headroom report including actual power headroom parameters to be provided for receipt by the secondary cell no later than in conjunction with an initial transmission following activation of the secondary cell.

8. An apparatus according to claim 7, wherein the processing system is arranged to cause the power headroom report to be provided following receipt of the scheduling information for the secondary cell, whereby to cause the power headroom report to be provided.

9. An apparatus according to claim 7, wherein the processing system is arranged to cause the power headroom report to be provided following receipt of an uplink grant on the secondary cell, whereby to cause the power headroom report to be provided.

10. An apparatus according to claim 7, wherein the processing system is arranged to cause the power headroom report to be provided in an initial subframe after the activation of the secondary cell which has a valid uplink grant, whereby to cause the power headroom report to be provided.

11. An apparatus according to claim 7, wherein the processing system is arranged to cause at least one of actual power headroom or P_{cmax} to be provided, whereby to cause the power headroom report to be provided.

12. An apparatus according to claim 7, wherein the processing system is arranged to receive the command at subframe n, to receive the scheduling information at subframe n+8, and wherein the processing system is arranged to cause the power headroom to be provided at subframe n+12, whereby to cause the power headroom report to be provided

13. An apparatus according to claim 7, wherein the apparatus is embodied by a mobile telephone.

14. An apparatus according to claim 7, further comprising user interface circuitry arranged to facilitate user control of at least some functions of the mobile telephone through use of a display.

15. A computer readable memory storing at least a set of instructions, which, when executed by a mobile terminal causes the mobile terminal to perform the steps of:
receiving a command from a primary cell indicating that a connection with a secondary cell is to be activated;
receiving scheduling information for the secondary cell; and
causing a power headroom report including actual power headroom parameters to be provided for receipt by the secondary cell no later than in conjunction with an initial transmission following activation of the secondary cell.

16. A computer readable memory according to claim 15, wherein the instructions for causing the power headroom report to be provided comprise instructions for causing the power headroom report to be provided following receipt of the scheduling information for the secondary cell.

17. A computer readable memory according to claim 15, wherein the instructions for causing the power headroom report to be provided comprise instructions for causing the power headroom report to be provided following receipt of an uplink grant on the secondary cell.

18. A computer readable memory according to claim 15, wherein the instructions for causing the power headroom report to be provided comprise instructions for causing the power headroom report to be provided in an initial subframe after the activation of the secondary cell which has a valid uplink grant.

19. A computer readable memory according to claim 15, wherein the instructions for causing the power headroom report to be provided comprise instructions for causing at least one of actual power headroom or P_{cmax} to be provided.

20. A computer readable memory according to claim 15, wherein the instructions for receiving the command comprise instructions for receiving the command at subframe n, the instructions for receiving the scheduling information comprise instructions for receiving the scheduling information at subframe n+8, and wherein the instructions for causing the power headroom report to be provided comprise instructions for causing the power headroom report to be provided at subframe n+12.
